(19) United States
(12) Patent Application Publication
(10) Pub. No.: US 2025/0381538 A1
(43) Pub. Date: Dec. 18, 2025

(54) APPARATUS FOR MIXING AND/OR CONDITIONING POWDERY MATERIALS AND METHOD OF OPERATING THE SAME

(71) Applicant: Rösler Holding GmbH, Bad Staffelstein (DE)

(72) Inventors: Domenik BRAUNROTH, Coburg (DE); Moritz BECK, Bad Staffelstein (DE); Florian MÜLLER, Ebern (DE)

(21) Appl. No.: 19/238,695

(22) Filed: Jun. 16, 2025

(30) Foreign Application Priority Data
Jun. 17, 2024 (DE) 102024116987.7

(51) Int. Cl. B01F 31/60; B01F 23/60; B01F 35/22; B01F 35/221; B29C 64/314; B33Y 40/10

(52) U.S. Cl. CPC B01F 31/60; B01F 23/60; B01F 35/2209; B01F 35/2217; B01F 35/2218; B29C 64/314; B33Y 40/10

(57) ABSTRACT

An apparatus for mixing and/or conditioning powdery materials through fluid-free fluidization comprises a movably supported container that defines a first processing chamber for receiving powdery material; an oscillation generator by which a powdery material located in the processing chamber can be subjected to an oscillation, in particular a sinusoidal oscillation, during operation; and a control unit that controls the oscillation generator.

### CROSS-REFERENCE TO RELATED APPLICATIONS

This application claims the benefit of German Patent Application No. 102024116987.7, filed on Jun. 17, 2024. The entire disclosure of the application referenced above is incorporated herein by reference.

The invention relates to an apparatus for mixing and/or conditioning powdery materials and to a method of operating the same.

In some technical applications, particularly high demands are placed on the homogeneity of powders and in particular of mixtures that consist of at least two powder components. Examples of this are applications for sintered materials, mixing tasks in the pharmaceutical or chemical industry or the provision of conditioned powder as input materials in additive manufacturing (e.g. plastic SLS process).

Mixtures of two or more powdery components are usually produced in mechanical mixers (equipped with stirring units, screws, rotating paddles, static mixing elements, double cone mixers, etc.) or by means of a fluidization in a fluidized bed. During the fluidization, powdery materials are suspended in a fluid flow field to mix them effectively. In this respect, a fluid, typically air or another gas, is conducted from the bottom to the top through the powdery material, whereby the particles above the so-called loosening point are mobilized and can thus be mixed easily and also in a manner gentle on the particles. This process is used in industrial applications, such as in the food, pharmaceutical and chemical industries, to produce homogeneous mixtures.

Both procedures are, however, associated with disadvantages.

Mechanical mixers sometimes require long mixing times until homogeneous mixtures are produced. With powdery substances in particular, long mixing times can lead to an overstressing of the powder particles and can adversely change their size distribution and structure.

A major disadvantage of the fluidization by gas (e.g. air) is that the total gas that is introduced into the bulk material to fluidize the powder must also leave the bulk material again. In this respect, depending on the gas velocity, particles of different sizes are also discharged that then have to be separated again outside the bulk material via separation units (e.g. filters, cyclones). Further measures may possibly be required in the exhaust gas purification to comply with environmental regulations (e.g. dust ingress via the exhaust air), for occupational safety (e.g. explosion protection) or for health protection (e.g. dust contamination of the breathing air). The discharged powder is lost to the process unless it is returned and is then in turn mixed in again. However, this requires a considerable additional apparatus effort. Due to the separation in filters or cyclones, the powder particles are also mechanically stressed and can in so doing be changed in their size distribution and structure.

In technical applications, processes in which solid bulk materials are fluidized without a fluid throughflow are usually not used for mixing. Such fluid-free fluidizations without a supplied external fluid flow (hereinafter “fluid-free fluidization”) are e.g. based on the application of vibrations to the particle bed. By selecting the frequency and amplitude correctly, the powder particles are set in motion, can be kept in suspension and in this state exhibit similar behavior to a conventional fluidized bed with a gas flow fed from the outside.

For mixing powders, e.g. plastic powders, plastic-metal hybrid powders or (light) metal powders having an average grain size of less than 200 μm, an apparatus is required with which an effective homogenization of the powder mixture is possible without subjecting the powder to strong mechanical stress in the mixing process or in upstream or downstream processes and thus adversely changing its properties for the further use. Furthermore, the mechanical structure and the mixing principle used should be designed such that complex active processes for cleaning escaping fluids (gases), for instance to comply with guidelines and requirements from environmental protection, occupational safety and health protection, can be omitted.

This object is satisfied by an apparatus having the features of claim 1.

The apparatus comprises at least one movably supported container that defines a first processing chamber for receiving powdery material. Furthermore, the apparatus comprises an oscillation generator, also called a vibration generator or an oscillator, by which a powdery material located in the processing chamber can be subjected to an oscillation during operation, and a control unit that controls the oscillation generator.

The processing chamber can function as a mixing chamber in which at least two different powdery materials are placed to mix them together. Alternatively or additionally, the processing chamber can also be used to condition a powder or a powder mixture with respect to certain physical properties. This may be necessary if important physical properties of a powder or a powder mixture, such as the homogeneity of the particle size distribution, the flowability or the moisture of the powder, have changed for the further processing steps, e.g. due to long storage times or transport.

The design of the apparatus makes it possible that the fluidization of the powder bed can take place solely by subjecting the powder to the oscillation generated by the oscillation generator without the conventional introduction of fluids. The apparatus thus enables a fluidization without discharging particles or gases.

In particular in the case of mechanically sensitive powders, the apparatus moreover also offers the advantage that a good mixing through is achieved in a quicker and simultaneously more gentle manner by the fluidization by means of oscillation than would be possible when using mechanical mixing devices.

Advantageous embodiments of the invention are described in the following description, in the drawing and in the dependent claims.

The oscillation is in particular a sinusoidal or sinusoidal-like oscillation. Such an oscillation is particularly suitable for fluidizing the powders such that a fluidized bed or a pulsating fluidized bed is formed.

It has proven to be particularly effective if the oscillation has a predominantly vertical component, in particular if it takes place substantially vertically. The particles are thereby upwardly accelerated in the powder bed against the force of gravity. With a suitable combination of frequency and amplitude, no gas is thereby fed into the apparatus, but gas (e.g. air) from the environment is sucked into the bed. This gas accumulates around the particles and thus supports their gentle mobilization and also congregates into small or larger gas bubbles or even flat gas fronts that then rise, starting from the base of the processing chamber or optionally present installed components or from the powder bed, as larger gas volumes in the bed. In this way, in the apparatus, a fluidization is produced whose properties with respect to the mixing through of the powder components are similar to those in pulsating fluidized beds or boiling liquids. However, no external fluid flow is required in the apparatus that would then also have to leave the powder bed again and, on leaving, would possibly take along powder particles that would then have to be separated again in a complex manner.

The apparatus can therefore be designed such that it does not comprise or have any means for the flowing through of a powder by a gas or another fluid.

The oscillation is not limited to an oscillation that takes place substantially vertically, i.e. perpendicular to a horizontal in the direction of gravity, even though an apparatus configured in this way is an advantageous embodiment of the present invention. For example, the oscillation can only have a vertical component, i.e. can take place in one direction inclined to the horizontal plane.

The container can therefore in particular be vertically movably supported.

One installed component or a plurality of installed components can be provided in the processing chamber. Examples of suitable installed components are paddles, sieve bottoms or metal sheets. The presence of such installed components can support the fluidization and the mixing through and/or the conditioning. In contrast to a mechanical mixer, however, these installed components can in particular be attached in a fixed position, i.e. not movably relative to the walls or the base of the processing chamber, during the fluidization.

However, the installed components can in particular be releasable or can be configured such that they can be removed from the processing chamber, for example can be lifted out upwards, wherein the removal can take place during or after the completion of the mixing or conditioning process. Advantageously, the removable installed components are configured such that they allow the passage of particles below a predefined particle size, for example as a sieve bottom or perforated metal sheet. For example, in a design of the installed components as a sieve bottom, the powder can flow out through the holes and remains in the processing chamber, while the larger agglomerates, pieces or components remain on the sieve bottom and can be lifted out upwards with it. Thus, removable installed components can also support downstream process steps such as the removal of agglomerates and pieces or the removal of components from powder bed-based methods for additive manufacturing.

The oscillation generator can, for example, be a vibration motor, a magnetic vibrator, a piston vibrator, a ball vibrator, a roller vibrator, a turbine vibrator or a structure-borne sound generator. A plurality of oscillation generators can also be provided in the apparatus.

The apparatus can comprise a coupling between the container and the oscillation generator, said coupling being configured such that, during operation, the oscillation is transmitted via a base and/or a wall of the container to a powdery material located in the first processing chamber. For example, a mechanical coupling is suitable for this purpose. The oscillation generator can, for example, be arranged below or to the side of the container. The container can, for example, be attached to a base plate that is excited to oscillate by an oscillation generator arranged under the base plate.

The first processing chamber can include one installed component or a plurality of installed components that is/are configured such that, during operation, the oscillation is transmitted via the installed component or the plurality of installed components to a powdery material located in the first processing chamber. In this respect, the oscillation excitation of the powdery material in the processing chamber therefore takes place via oscillation-excited installed components such as paddles, sieve bottoms or metal sheets.

In this case, it is possible for the first processing chamber to be designed without its own oscillation excitation of the base and the wall so that the oscillation is only transmitted via the installed components in the processing chamber.

However, it is also possible to combine the two above-mentioned possibilities, i.e. to transmit the oscillation during operation both via a base and/or a wall of the container and via installed components provided in the first processing chamber to a powdery material located in the first processing chamber.

The apparatus can comprise at least one supply unit, in particular at least two supply units, for receiving powdery materials to be mixed and/or to be conditioned. The supply units serve as storage vessels for storing powdery materials that are to be fed to the first processing chamber and are to be subjected to a fluidization there. If the apparatus is used to mix two or more powdery materials, it can be advantageous to provide a separate supply unit for each powdery material to be fed. This means that the apparatus can comprise two or more first supply units.

The apparatus can comprise at least one first conveying unit, in particular at least two first conveying units, for feeding powdery materials into the processing chamber.

Alternatively or additionally, the apparatus can comprise a second conveying unit for discharging powdery materials from the processing chamber.

The conveying units can be of a passive type, i.e. they can, for example, be configured as pipelines or hoses, or of an active type, i.e. they can, for example, be configured as screw conveyors or vibration channels. The powder to be conveyed can be transported by the effect of gravity, but can also be sucked into the apparatus by negative pressure, i.e. by means of a pump, for example through a hose and/or a suction lance.

A first conveying unit can, for example, connect a possibly present supply unit, which serves as a storage container for a powdery material to be mixed and/or to be conditioned, to the first processing chamber. If the apparatus is used to mix two or more powdery materials, it can be advantageous to provide a separate first conveying device for each powdery material to be fed. This means that the apparatus can comprise two or more first conveying units.

A second conveying unit can, for example, connect the first processing chamber to a container that receives mixed and/or conditioned powdery materials after the fluidization has taken place.

Supply units, first conveying devices and second conveying devices help to improve the process stability and reduce the dust pollution in the environment of the system, in particular by reducing the handling of the individual powdery materials.

The apparatus can include a sieve that retains agglomerates and/or foreign bodies and prevents them from entering the processing chamber. Furthermore, the apparatus can comprise aids that are arranged at the sieve and that support the sieving process by exciting the sieve to vibrate, for example, vibration motors and/or ultrasonic generators. The sieving process can thereby be facilitated and accelerated. Furthermore, agglomerates possibly present in the fed powder can be broken up and comminuted in this way. However, these aids do not serve for the fluidization, but only act on the sieve.

The apparatus can comprise a storage chamber for receiving powdery materials from the first processing chamber. A plurality of storage chambers can also be provided. The storage chambers serve to collect the mixed and/or conditioned powdery materials after the fluidization has taken place. The dust pollution of the environment and the manual effort for the removal, storage and transport of the finished powder from the apparatus is thereby reduced.

The apparatus can comprise an emptying unit for emptying the first processing chamber, wherein the emptying unit is configured to transport powdery materials from the first processing chamber into a storage chamber or out of the apparatus, in particular by gravity or by a driven conveying. This facilitates the handling of the finished powder and reduces the dust pollution.

The emptying of the processing chamber can in particular be effected by gravity or by a driven conveying. The emptying of the processing chamber can in particular take place such that the powdery material is received in a storage chamber in this respect.

For example, a simple emptying unit can comprise an opening provided in the wall or at the base of the processing chamber and a flap, wherein the opening can be closed by the flap during operation (during the fluidization) and the flap can be opened after the fluidization has taken place so that the mixed and/or conditioned powdery materials can fall out of the processing chamber under the effect of gravity and can e.g. be collected in a suitable vessel outside the apparatus or in a storage chamber within the apparatus. The flap can, for example, be designed as a pivoting flap or as a sliding flap.

Alternatively, a connection for a hose can be provided at the base of the container or of the processing chamber. The processing chamber can be emptied via a connected hose, for example by sucking in the powder by means of negative pressure or due to the effect of gravity.

The apparatus can comprise a gas monitoring unit that is configured to detect, to set and/or to regulate the composition, in particular the gas humidity, of a gas that is in contact with or is to be brought into contact with powdery material to be mixed and/or to be conditioned.

Thus, the powdery material can, for example, be brought into contact with a gas atmosphere of set and constant moisture in the apparatus, which allows the setting of the moisture, in particular the surface moisture, of a powdery material. This is advantageous since the process stability of downstream use steps for the powdery materials mixed and/or conditioned in the apparatus, for example in the case of plastic powders for additive manufacturing (such as for polyamide in plastic SLS applications), depends heavily on the moisture, in particular the surface moisture, of the powders.

Alternatively or additionally, other parameters, for instance the oxygen content of the gas, can be detected, set or regulated. This can be advantageous, for example, if metal powders that can be oxidized by atmospheric oxygen are to be mixed or conditioned in an inert gas atmosphere (nitrogen, argon) with the lowest possible oxygen content.

The powder can be brought into contact with the gas, whose composition, in particular moisture, is set or regulated as explained above, in the first processing chamber or in another part of the apparatus. However, the gas does not serve for the fluidization, but merely forms the atmosphere within the apparatus or within a part of the apparatus.

The powdery material can be brought into contact with the gas within the first processing chamber, in particular during the fluidization.

In the apparatus, a second processing chamber can additionally also be provided, for example for bringing the gas into contact with the powdery material. The second chamber can be configured such that a powdery material located in the second processing chamber can also be subjected to an oscillation, in particular a sinusoidal oscillation, by the oscillation generator during operation. This is achieved in the same way as previously explained for the first processing chamber, i.e., during operation, the oscillation is transmitted via a base and/or a wall of the container and/or via installed components provided in the second processing chamber.

The powdery material can be brought into contact with the gas in the first processing chamber and/or, if present, in the second processing chamber. Regardless of the chamber in which the contact with the gas takes place, it is, however, in any case advantageous if the contact takes place during the fluidization since the individual particles are finely distributed in the gas in this state and are thus easily accessible to the gas.

The apparatus can comprise one or more measurement devices that are configured to detect, to store and/or to offset powder parameters and/or process parameters against one another.

Measurement devices provided at suitable positions in the apparatus, e.g. sensors, can support the monitoring and control of the mixing process and/or conditioning process taking place in the apparatus. Examples of measurement devices are, for example, load cells, optical or inductive filling level sensors in processing chambers, storage chambers or supply units, regulated valves and shut-off members for powders, gases or liquids, humidity sensors, measurement devices for the frequency and/or amplitude of the oscillation, and so on.

The powder parameters can comprise at least one physical parameter of at least one powdery material fed to the first processing chamber, wherein the physical parameter can in particular be selected from particle size, particle size distribution, fed volume and fed mass.

In the simplest case, the control unit for controlling the oscillation generator can be an ON/OFF switch for switching the oscillation generator on and off. In such a case, the apparatus can, for example, be configured so that the frequency and amplitude of the oscillation can be manually set at the oscillation generator. In particular, the control unit is, however, configured to control at least one of the amplitude and frequency of the oscillation, advantageously both the amplitude and the frequency of the oscillation. The control unit can furthermore also perform one or more regulation tasks.

The control unit can be configured to control or regulate one or more of the process steps that are carried out in the apparatus on powdery materials and that are in particular selected from metering, feeding, classifying, mixing, conditioning and discharging. The production of a homogeneous powdery material during the mixing and/or conditioning is thereby facilitated.

The control unit can in particular be configured to control one or more parameters of the mixing and/or conditioning. Said parameters can in particular be the parameters of the material (i.e. the selection and the quantity of the material to be fed), the oscillation frequency, the oscillation amplitude, the mixing ratio and/or the mixing rate.

The control unit can be configured to control the volume and/or the mass of at least one fed powdery material, in particular of all the fed powdery materials. The advantage of a precise metering and an improved process stability thereby results.

The present invention also relates to a method of operating an apparatus according to any one of the claims 1 to 14, wherein at least one powdery material is introduced into the first processing chamber and is transferred into a fluidized bed by fluidization and energy required for this purpose is introduced via the oscillation generator in that the oscillation generator applies an oscillation, in particular a sinusoidal oscillation, to the powdery material. This method enables the gentle mixing and/or conditioning of powdery materials without discharging gas and dust.

The fluidization taking place in the method is in particular a fluid-free fluidization that is caused solely by the oscillation and not by other measures, such as introducing a fluid into the container.

In the method, the deviation of at least one physical parameter of the at least one powdery material from a desired value can be determined, wherein the physical parameter is in particular an average particle size, a particle size distribution and/or a particle mass distribution. This monitoring can, for example, take place by means of the control unit.

The advantage thereby results that the effectiveness of the mixing and/or conditioning can be assessed by using a characteristic parameter that is suitable for this purpose, in particular with respect to the particle size distribution (e.g. mean values, median values, minimum values, maximum values, percentiles, sum distribution curve with respect to mass or particle size, d10, d50, d90 values), to describe the mixing quality or the homogeneity and it is monitored how greatly this variable in one or more samples from a mixing or conditioning process deviates from the target value of one or more characteristic variables.

Particle size distributions of similar material systems are subject to certain fluctuations. For the following process steps, it is not always necessary for all the characteristic variables to lie within very narrow tolerance windows, but ranges are permissible.

A maximum permitted deviation can therefore in particular be defined. It can, for example, be defined as a relative (percentage) deviation. For example, it can be monitored whether a characteristic variable deviates by less than ±20% from a desired value. Good further processing properties can be given in some applications if one or more of the above-mentioned characteristic values are within this range.

For more demanding applications, it can be advantageous if the relative deviation from a desired value, in particular with respect to a particle size distribution, lies within a narrower tolerance window. For example, it is possible to monitor whether a characteristic variable in a plurality of samples from the same mixing or conditioning process deviates from a desired value by less than ±10%, in particular by less than ±5%.

The powdery material can be a (light) metal powder, a plastic powder or a plastic-containing powder (e.g. a plastic-metal hybrid powder), in particular with an average grain size of less than 200 μm. With such materials, a gentle fluid-free fluidization has a particularly advantageous effect. For example, powders for additive manufacturing processes can be effectively mixed and/or homogenized in their properties. In particular, the powdery material can be a plastic powder or a plastic-containing powder.

The fluidization can take place in a time sequence of two or more fluidization phases, wherein in particular at least two fluidization phases differ with respect to at least one parameter.

Depending on the powder properties, the time development of the feeding of individual powder components and the aim of the mixing or conditioning task, it can be advantageous to divide the fluidization process into different phases. These phases, for example, differ through different system conditions in the mixing chamber (for example, filling level, average particle size, moisture of the particles, flowability of the particle bed). It can therefore be advantageous to adapt process parameters such as the frequency and amplitude of the oscillation to the respective phases. A time sequence of different fluidization phases can therefore result that can inter alia be characterized by different combinations of parameters for a system setting. The control of the time sequence of these phases with their respective parameter combinations can advantageously take place by means of the at least one control unit.

In the method, the control unit can control the time sequence of steps that are upstream and/or downstream of the fluidization. Said steps can in particular be one or more steps that are selected from provision steps, feeding steps, discharge steps, storage steps and conditioning steps as well as from support processes associated with these steps, such as gas provision, gas humidification, discharge of powder agglomerations. For example, a semi-automated or automated feed and/or discharge can thus be realized in addition to a manual one.

This enables a more precise metering, a higher process stability and a safer powder handling, e.g. with respect to dust formation.

The control unit can, for example, detect and/or regulate the provision of the powdery material to be mixed and/or to be conditioned with respect to the quantity to be provided and, if two or more powdery materials are mixed, with respect to the mixing ratio.

The quantity and, if necessary, the mixing ratio is in particular detected and regulated via the volume and/or the mass of the fed powdery material using default values and stored material data. The default values and the material data can be stored in the control unit. The advantage of a precise metering and an improved process stability thereby results.

The control unit can detect and/or regulate at least one parameter of the fluidization, in particular selected from fluidization duration, amplitude of the oscillation, frequency of the oscillation, type of the fluidization phases and number of the fluidization phases. The production of a homogeneous powdery material during the mixing and/or conditioning is thereby facilitated.

The control unit can detect and/or regulate at least one physical parameter of the powdery material that is in particular selected from flowability, surface charge, surface moisture or total moisture.

This can take place before, during or after the fluidization.

For example, the regulation of the surface moisture of a powder can take place as already described further above, i.e. by bringing the powdery material in the apparatus into contact with a gas atmosphere of set and constant moisture, which allows the setting of the moisture, in particular the surface moisture of a powdery material, wherein the gas moisture is set by means of a gas monitoring unit provided in the apparatus.

The measurement devices can generate measurement values that are stored in the control unit. For example, process-relevant material data of the handled solids and their temporal change in the process can thus be acquired via sensors and other measurement devices. Process-relevant machine data and their changes in the process can also be acquired.

The stored measurement values can be used for a continuous process monitoring of the fluidization process.

The control unit can use the control variables, product parameters and sensor values via characteristic curves, closed loops, algorithms or artificial intelligence to regulate and optimize the mixing or conditioning process during ongoing operation.

The present invention will be described in the following purely by way of example with reference to an advantageous embodiment and to the enclosed drawings. There are shown:

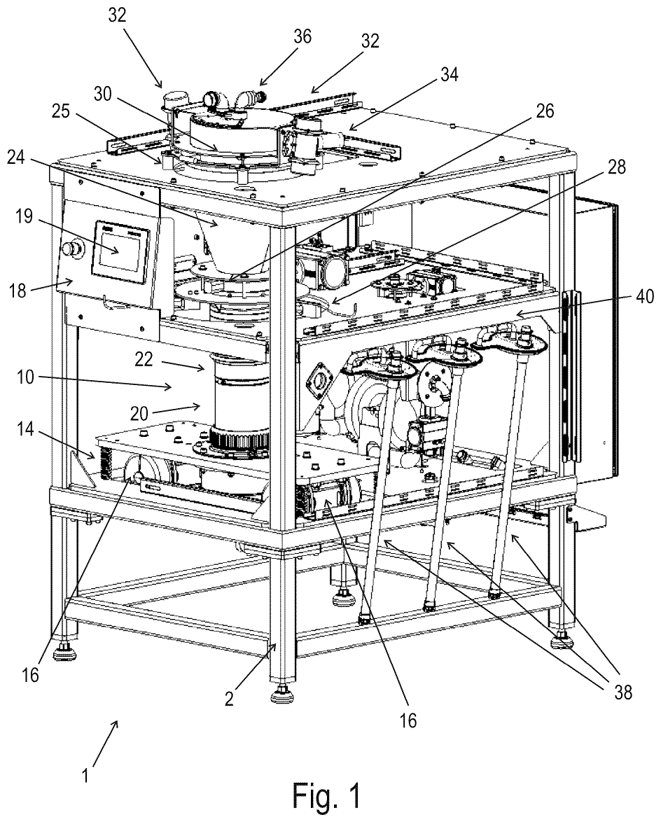

FIG. 1 a side view of an apparatus according to the invention;

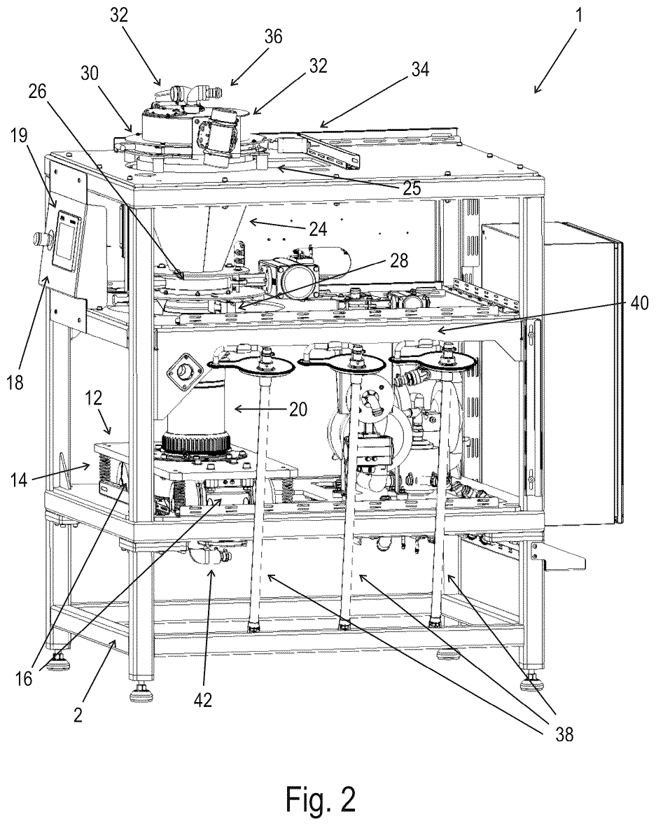

FIG. 2 a further side view of the apparatus;

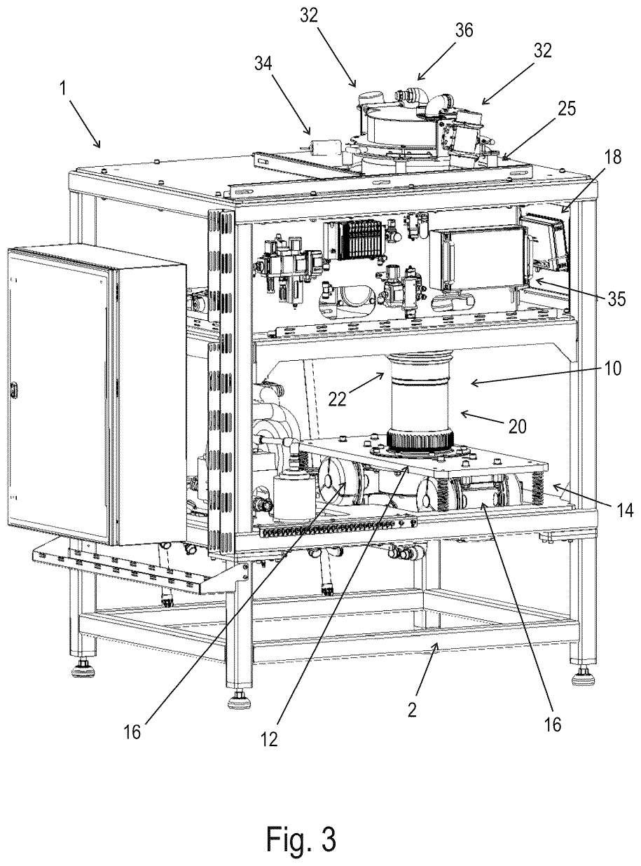

FIG. 3 a further side view of the apparatus;

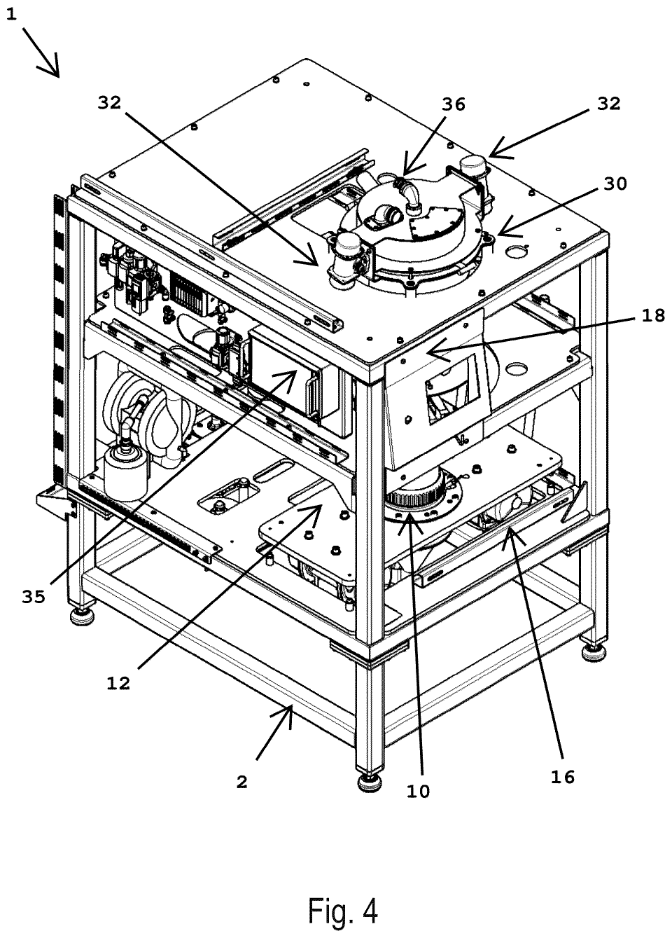

FIG. 4 a further side view of the apparatus; and

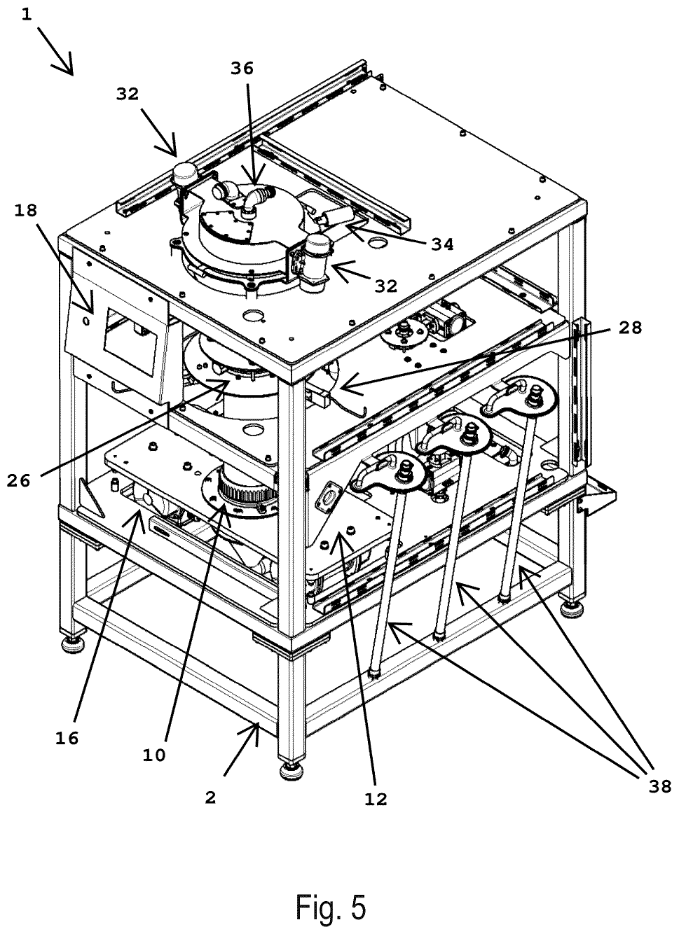

FIG. 5 a further side view of the apparatus.

The apparatus 1 shown in FIGS. 1 to 5 has a container 10 that is fastened to a horizontal base plate 12 that is arranged below it and that is in turn connected to a base frame 2 of the apparatus 1 via springs 14. The container 10 is thus movably supported at least in a vertical oscillation direction. An oscillation generator 16 by means of which the container 10 can be set into oscillations, in particular vertical oscillations, is attached to the lower side of the base plate 12. The oscillation generator 16 is connected to a control unit 18 by means of which the oscillation generator 16 can at least be switched on and off. In particular, the frequency and/or the amplitude of the oscillation can be set by means of the control unit 18. The control unit 18 has a display 19 that can display the information about the operating status of the apparatus 1, process parameters (e.g. frequency, amplitude) and/or measurement values (e.g. powder weight, gas humidity). The display 19 can be configured as a touchscreen and can thus allow a control of the apparatus 1 by touching the display 19. The control unit 18 can furthermore include a non-volatile memory (not shown) on which, for example, material data for powders and/or predefined fluidization parameters can be stored. The non-volatile memory can also be used to record process parameters, to log mixing and conditioning processes performed with the apparatus 1 and/or to store measurement values measured during the operation of the apparatus 1.

Furthermore, the container 10 defines a processing chamber 20 for receiving a particle bed. A bellows 22 is arranged above the processing chamber 20 and connects the processing chamber in a vertically flexible manner to a hopper 24 for feeding powdery materials.

Between the hopper 24 and the bellows 22 there is a shut-off valve 26 which is, for example, configured as a butterfly valve and via which the gravity-based or driven feeding of powder given into the hopper 24 into the processing chamber 20 can be controlled. The shut-off valve 26 can in particular be opened and closed via the control unit 18. For the metering and, if necessary, for the definition of the mixing ratio, the weight of a powder present in the hopper 24 can be determined by means of a plurality of load cells 28 arranged below the hopper 24. The weight determined by the load cells 28 can be shown on the display 19 and can in particular be stored in a non-volatile memory of the control unit 18.

A plurality of rubber buffers 25 are arranged between the upper end of the hopper 24 and the base frame 2. A sieve 30 is furthermore located at the upper end of the hopper 24. It serves to retain coarser particles and agglomerates as well as any foreign bodies possibly present in the powder. To facilitate the passage of the powder through the sieve 30 and to break up agglomerates, in particular two vibration motors 32, an ultrasonic generator 34 and a control unit 35 for the ultrasonic generator are provided, for example. They can only support the feeding of the powder and do not have to be involved in the subsequent fluidization.

The feeding of powder takes place via a connection 36 above the sieve 30. A hose (not shown) can be connected to the connection 36 and can in turn be connected to a suction lance 38. The suction lance 38 can be removed from a holder 40 to be inserted into a storage container (not shown) in which a powder to be fed is stored. The powder that first flows through the sieve 30 can then be sucked into the apparatus 1 by means of a negative pressure that can, for example, be generated by a membrane pump (not shown). The powder material that has passed through the sieve 30 can, when the shut-off valve 26 is open, fall through the bellows 22 into the container 10, and thus into the processing chamber 20, under the effect of gravity.

This process can be repeated until all the desired powder components of a powder mixture to be produced are in the processing chamber 20.

At the lower end of the apparatus 1, below the base plate 12 and the oscillation generator 16, there is an outlet 42 (FIG. 2) via which the mixed and/or conditioned powder can be removed from the apparatus 1 after the fluidization has taken place and can be received in a container (not shown) provided for this purpose. The removal can, similarly to as explained above for the feeding, take place by suction, e.g. by attaching a hose (not shown) and by applying negative pressure by means of a pump. Alternatively, a removal of the powder can, for example, also take place by the effect of gravity.

1. An apparatus for mixing and/or conditioning powdery materials through fluid-free fluidization, said apparatus comprising:
a movably supported container that defines a first processing chamber for receiving powdery material;
an oscillation generator by which a powdery material located in the processing chamber can be subjected to an oscillation during operation; and
a control unit that controls the oscillation generator.

2. The apparatus according to claim 1,
wherein the apparatus comprises a coupling between the container and the oscillation generator, said coupling being configured such that, during operation, the oscillation is transmitted via a base and/or a wall of the container to a powdery material located in the first processing chamber.

3. The apparatus according to claim 1,
wherein the first processing chamber includes one installed component or a plurality of installed components that is/are configured such that, during operation, the oscillation is transmitted via the installed component or the plurality of installed components to a powdery material located in the first processing chamber,
and/or the first processing chamber includes one installed component or a plurality of installed components that are fixedly attached; and/or
wherein the installed components are configured such that they can be removed from the processing chamber and/or allow the passage of particles having a particle size below a predefined particle size.

4. The apparatus according to claim 1, comprising:
a storage chamber for receiving powdery materials from the first processing chamber.

5. The apparatus according to claim 1, comprising:
a gas monitoring unit that is configured to detect and/or to regulate the composition of a gas that is in contact with or is to be brought into contact with powdery material to be mixed and/or to be conditioned.

6. The apparatus according to claim 8,
wherein a powdery material located in the second processing chamber can also be subjected to an oscillation, by the oscillation generator during operation.

7. The apparatus according to claim 1, comprising:
one or more measurement devices that are configured to detect, to store and/or to offset powder parameters and/or process parameters against one another.

8. The apparatus according to claim 7,
wherein the powder parameters comprise at least one variable that is selected from particle size, particle size distribution, fed volume and fed mass.

9. The apparatus according to claim 1,
wherein the control unit is configured to control one or more process steps that are carried out in the apparatus on powdery materials.

10. The apparatus according to claim 9,
wherein the control unit is configured to control the parameters of the mixing and/or conditioning.

11. The apparatus according to claim 9,
wherein the control unit is configured to control the volume and/or the mass of at least one fed powdery material.

12. A method of operating an apparatus for mixing and/or conditioning powdery materials through fluid-free fluidization, said apparatus comprising:
a movably supported container that defines a first processing chamber for receiving powdery material;
an oscillation generator by which a powdery material located in the processing chamber can be subjected to an oscillation, in particular a sinusoidal oscillation, during operation; and
a control unit that controls the oscillation generator, wherein at least one powdery material is introduced into the first processing chamber and is transferred into a fluidized bed by fluidization and energy required for this purpose is introduced via the oscillation generator in that the oscillation generator applies an oscillation to the powdery material.

13. The method according to claim 12,
wherein the control unit determines a deviation of at least one physical parameter of the at least one powdery material from a desired value.

14. The method according to claim 12,
wherein the fluidization takes place in a time sequence of two or more fluidization phases.

15. The method according to claim 12,
wherein the control unit controls the time sequence of steps that are upstream and/or downstream of the fluidization.

16. A method according to claim 15,
wherein the control unit controls or regulates the provision of the powdery material to be mixed and/or to be conditioned with respect to the quantity to be provided and, if two or more powdery materials are mixed, with respect to the mixing ratio.

17. The method according to claim 12,
wherein the control unit detects and/or regulates at least one parameter of the fluidization.

18. The method according to claim 12,
wherein the control unit detects and/or regulates at least one physical parameter of the powdery material that is selected from flowability, surface charge, surface moisture or total moisture.

19. The method according to claim 12,
wherein the measurement devices generate measurement values that are stored in the control unit.

20. The method according to claim 19,
wherein the stored measurement values are used for a continuous process monitoring of the fluidization process.
